(19) United States
(12) Patent Application Publication
(10) Pub. No.: US 2008/0064351 A1
(43) Pub. Date: Mar. 13, 2008

(54) SYSTEM AND METHOD FOR LOCATION-BASED MEDIA RANKING

(75) Inventors: Assaf Landschaft, Munich (DE); Shajith C. Thengummootil, Bangalore (IN)

Correspondence Address: HITT GAINES, PC;LSI Corporation, PO BOX 832570, RICHARDSON, TX, 75083, US

(73) Assignee: Agere Systems, Inc., Allentown, PA (US)

(21) Appl. No.: 11/530,239

(22) Filed: Sep. 8, 2006

(51) Int. Cl. H04B 1/18

(52) U.S. Cl. 455/187.1

(57) ABSTRACT

The present invention provides a media-location ranker for use with a mobile electronic device. In one embodiment, the media-location ranker includes a media ranking unit configured to provide a media ranking of a plurality of media files. The media-location ranker also includes a location relating unit coupled to the media ranking unit and configured to produce a media-location ranking based on relating the media ranking to a location of the mobile electronic device. Additionally, the media-location ranker further includes a media playing unit coupled to the location relating unit and configured to select media files from the media-location ranking for playback consideration based on a playback location. The media-location ranker still further includes a ranking update unit coupled to the media playing unit and configured to update the media-location ranking based on playback preferences of media files at the playback location.

### TECHNICAL FIELD OF THE INVENTION

The present invention is directed, in general, to mobile electronic devices and, more specifically, to a media-location ranker, a method of generating a location-based media ranking and communication and positioning systems employing the ranker and the method.

### BACKGROUND OF THE INVENTION

Mobile electronic and communication devices, such as mobile phones, are increasingly used to accommodate more functions than just communication between users. Many have become portable entertainment centers having features that were only imagined a short time ago. For example, currently available mobile phones allow viewing of news, weather, sports and entertainment video updates as well as allowing cutting edge three-dimensional games to be played. Features such as video and audio on demand allow playing of video and audio clips. Movie and music fans can download content on their mobile phones that has both sharpness and clarity. These features allow a user to enrich their personal media experience through the media player associated with the mobile device.

Enhancing this personalized media experience for a mobile user has provided applications where ranking of audio and video content is used to generate a favorites play list. The favorites play list is a generated ranking of a collection of media content (e.g., a group of recorded songs). Existing play list systems may keep track of the content playing time and store this information in the media file's metadata. The number of accesses are stored in the media file's metadata and are extracted to generate the favorites play list. Generally, the access time of each selection or the access time of the latest accesses is stored in the metadata wherein the information is used to generate the media's ranking. These systems may also use this information to give content files higher or lower rating at certain times of the day, when the metadata of the files indicate that they were played, for example. However, existing favorites play lists do not consider that the media player may be on a device, such as a mobile phone, that is aware of its general location or perhaps even its geographic location.

Accordingly, what is needed in the art is a way to correlate media selections that enable enhanced media experiences to mobile users.

### SUMMARY OF THE INVENTION

To address the above-discussed deficiencies of the prior art, the present invention provides a media-location ranker for use with a mobile electronic device. In one embodiment, the media-location ranker includes a media ranking unit configured to provide a media ranking of a plurality of media files. The media-location ranker also includes a location relating unit coupled to the media ranking unit and configured to produce a media-location ranking based on relating the media ranking to a location of the mobile electronic device. Additionally, the media-location ranker further includes a media playing unit coupled to the location relating unit and configured to select media files from the media-location ranking for playback consideration based on a playback location. The media-location ranker still further includes a ranking update unit coupled to the media playing unit and configured to update the media-location ranking based on playback preferences of media files at the playback location.

In another aspect, the present invention provides a method of generating a location-based media ranking for use with a mobile electronic device. The method includes providing a media ranking of a plurality of media files and producing a media-location ranking based on relating the media ranking to a location of the mobile electronic device. Additionally, the method also includes selecting media files from the media-location ranking for playback consideration based on a playback location and updating the media-location ranking based on playback preferences of media files at the playback location.

The present invention also provides, in yet another aspect, a communication system. The communication system includes a mobile communications network employing a cellular grid and a mobile communication device coupled to the cellular grid wherein the mobile communication device includes a media-location ranker. The media-location ranker has a media ranking unit that provides a media ranking of a plurality of media files, and a location relating unit that produces a media-location ranking based on relating the media ranking to a location of the mobile electronic device. Additionally, the media-location ranker also has a media playing unit that selects media files from the media-location ranking for playback consideration based on a playback location, and a ranking update unit that updates the media-location ranking based on playback preferences of media files at the playback location.

The present invention additionally provides, in still another aspect, a global positioning system (GPS). The GPS includes a satellite positioning network and a mobile electronic device coupled to the satellite positioning network wherein the mobile electronic device includes a media-location ranker. The media-location ranker has a media ranking unit that provides a media ranking of a plurality of media files, and a location relating unit that produces a media-location ranking based on relating the media ranking to a location of the mobile electronic device. Additionally, the media-location ranker also has a media playing unit that selects media files from the media-location ranking for playback consideration based on a playback location, and a ranking update unit that updates the media-location ranking based on playback preferences of media files at the playback location.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a system diagram of an embodiment of a communication system constructed in accordance with the principles of the present invention;

FIG. 2 illustrates a system diagram of an embodiment of a global positioning system (GPS) constructed in accordance with the principles of the present invention; and

FIG. 3 illustrates a flow diagram of an embodiment of a method of generating a location-based media ranking carried out in accordance with the principles of the present invention.

### DETAILED DESCRIPTION

Embodiments of the present invention provide an enhanced media experience for users of mobile electronic devices that are aware of their location and employ media players. A media file may be provided as an audio file or a video file. The media file typically employs a defined data format or file structure wherein MP3, MPEG, WMA or AVI are exemplary although not exclusive. In one embodiment discussed, the mobile electronic device is employed as a mobile communication device in a communication system, such as a mobile phone employing a media player. In an alternative embodiment, the mobile electronic device is employed in a global positioning system (GPS) and may be, for example, a laptop computer, a PDA or a mobile phone having media players as well as an independent media player wherein all have GPS capability.

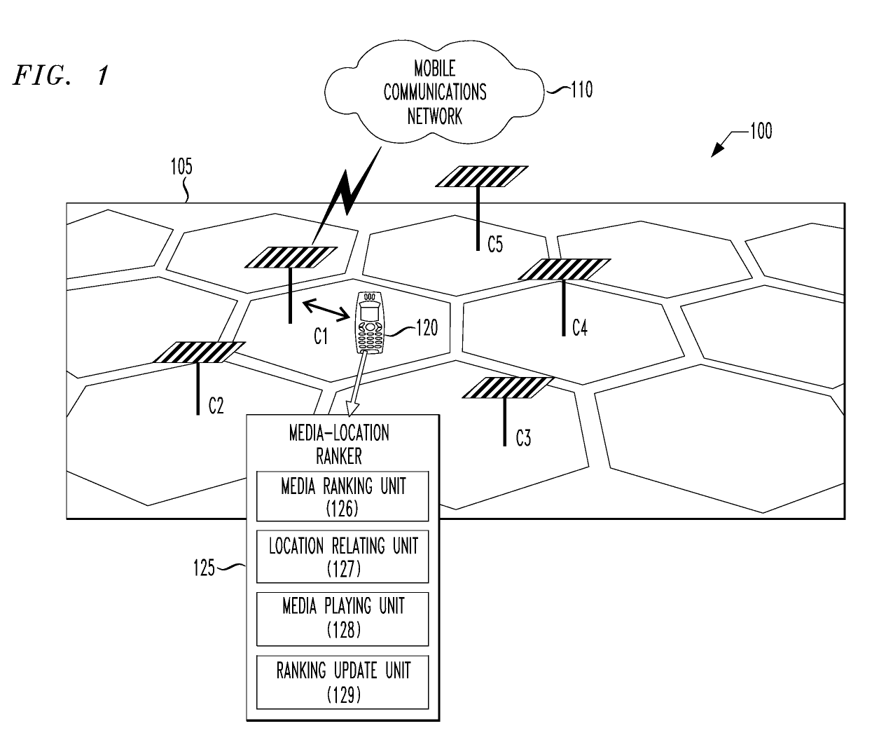

Referring initially to FIG. 1, illustrated is a system diagram of an embodiment of a communication system, generally designated 100, constructed in accordance with the principles of the present invention. The communication system 100 includes a cellular grid 105 having a plurality of communication cells C1-C5 that is coupled to a mobile communications network 110. The communication system 100 also includes a mobile communication device, which is a mobile phone 120 in the illustrated embodiment. In one embodiment of the present invention, the communication system 100 conforms to the Global System for Mobile Communications/Universal Mobile Telecommunications System (GSM/UMTS) standard.

Each of the plurality of communication cells C1-C5 employs a GSM mast (transmission antenna). Each of the GSM masts is associated with a Cell-ID. Gathering of these Cell-IDs along with their accompanying locations into a Cell-ID database allows identification of an approximate or geographic location for a mobile phone located within a cell that employs its GSM mast for transmission. In the communication system 100, the Cell-ID database may be contained in the mobile phone 120, or alternatively, it may be maintained in a network server and provided routinely to or upon request from the mobile phone 120. The Cell-ID database may be available either publicly or privately.

The location precision of the mobile phone 120, using either GSM or UMTS standards, is generally determined by the dimensions or sizes of each of the communication cells C1-C5. The mobile phone 120 is aware that it is located in the communication cell C1. The mobile phone 120 may also be able to receive signals originating from GSM masts in adjacent communication cells C2, C3, C4 or C5. Therefore, it may be possible to use this connection information to determine or calculate a more precise location of the mobile phone 120 in the communication cell C1.

In the illustrated embodiment, the mobile phone 120 includes a media-location ranker 125 that is functionally coupled to it. The media-location ranker 125 includes a media ranking unit 126 that provides a media ranking of a plurality of media files, and a location relating unit 127 that is coupled to the media ranking unit 126 and produces a media-location ranking based on relating the media ranking to a location of the mobile phone 120. The media-location ranker 125 also includes a media playing unit 128 that is coupled to the location relating unit 127 and selects media files from the media-location ranking for playback consideration based on a playback location. The media-location ranker 125 further includes a ranking update unit 129 that is coupled to the media playing unit 128 and updates the media-location ranking based on playback preferences of media files at the playback location.

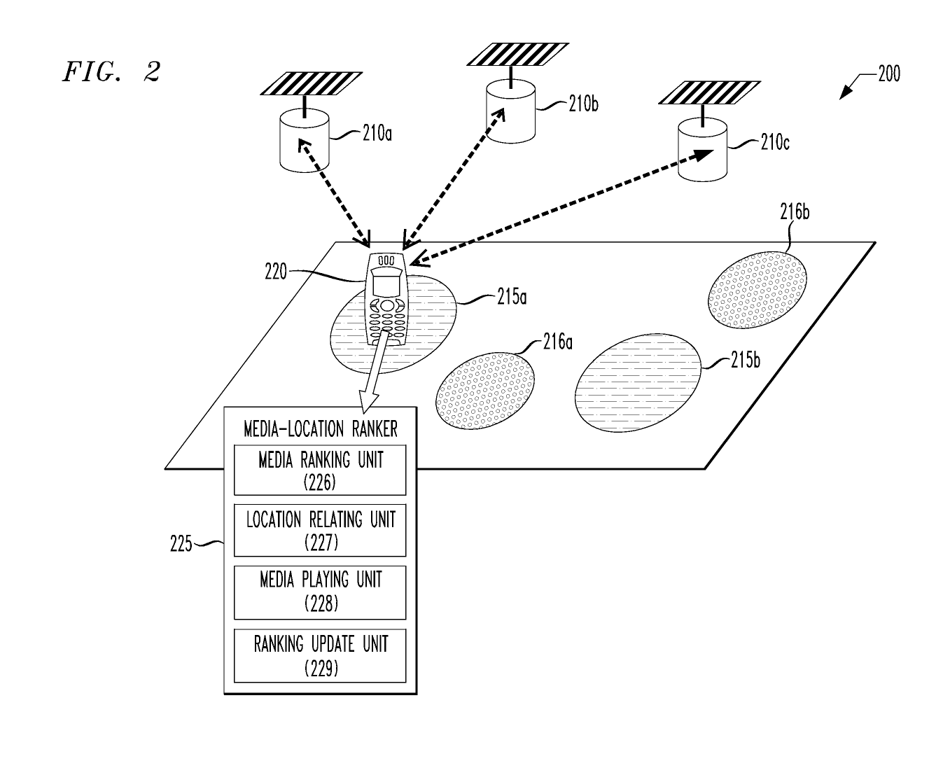

Turning to FIG. 2, illustrated is a system diagram of an embodiment of a global positioning system (GPS), generally designated 200, constructed in accordance with the principles of the present invention. In the illustrated embodiment, the GPS 200 includes a satellite positioning network employing positioning satellites 210a, 210b, 210c and a mobile electronic device, which is a mobile phone 220 having GPS capability coupled to the positioning satellites 210a, 210b, 210c. Embodiments of the present invention employ a first and second set of zones 215a, 215b and 216a, 216b corresponding to geographic locations having similar environmental characteristics.

Each of the first and second sets of zones 215a, 215b and 216a, 216b may correspond to a collection of parks, supermarkets, shopping malls or churches, for example. Each of these zones typically provides a more defined or refined location than the one achievable employing Cell-IDs in a communication system, as was discussed with respect to FIG. 1. When a media-location ranking is established for one the zones, say zone 215a for example, it can be applied to the zone 215b. Additionally, a media-location ranking may be established that restricts certain media content from being played in differing zones thereby corresponding to an inverse or negative ranking of media content between zones.

As provided in the mobile communication device, (i.e., the mobile phone 120) of FIG. 1, the mobile phone 220 includes a media-location ranker 225. In the illustrated embodiment, the media-location ranker 225 has a media ranking unit 226, a location relating unit 227, a media playing unit 228 and a ranking update unit 229 wherein each of the units perform the same basic functions as indicated for the media-location ranker 125.

Now, a discussion of various embodiments will be presented that generally may be employed with either the mobile communication system 100 or the GPS 200. The media ranking units 126, 226 provide a favorites play list wherein an example is shown in Table 1. The favorites play list organizes the media (e.g., song titles in this example) in a descending order of being accessed.

TABLE 1

| MEDIA | | ACCESS |
|---|---|---|
| RANKING | | NUMBER |
| (TOTAL) | SONG TITLE | (TOTAL) |
| 1 | A | 17 |
| 2 | B | 12 |
| 3 | C | 10 |
| 4 | D | 8 |
| 5 | E | 5 |
| 6 | F | 3 |

Table 1 indicates that the song title A has been accessed a total of 17 times thereby resulting in a highest media ranking (media ranking 1) of the song titles shown. In one embodiment, the media ranking may be performed by a user in a manual selection process wherein the user assigns certain songs to certain ranking positions. This corresponds to a manual ranking process and may constitute a ranking initialization. Alternatively, this favorites play list may be downloaded from an external source initially.

Table 2 shows an extension of the favorites play list of Table 1 wherein the total number of accesses is delineated for locations L1, L2 and L3.

TABLE 2

| MEDIA | | ACCESS | ACCESS | ACCESS | ACCESS |
|---|---|---|---|---|---|
| RANKING | SONG | NUMBER | NUMBER | NUMBER | NUMBER |
| (TOTAL) | TITLE | (TOTAL) | (L1) | (L2) | (L3) |
| 1 | A | 17 | 8 | 7 | 2 |
| 2 | B | 12 | 5 | 3 | 4 |
| 3 | C | 10 | 9 | 0 | 1 |
| 4 | D | 8 | 1 | 2 | 5 |
| 5 | E | 5 | 0 | 1 | 4 |
| 6 | F | 3 | 3 | 0 | 0 |

The location relating units 127, 227 employ this information to generate the media-location ranking for a location. Table 3 indicates the media-location ranking for the location L1.

TABLE 3

| MEDIA- | | | | | |
|---|---|---|---|---|---|
| LOCATION | | ACCESS | ACCESS | ACCESS | ACCESS |
| RANKING | SONG | NUMBER | NUMBER | NUMBER | NUMBER |
| (L1) | TITLE | (TOTAL) | (L1) | (L2) | (L3) |
| 1 | C | 10 | 9 | 0 | 1 |
| 2 | A | 17 | 8 | 7 | 2 |
| 3 | B | 12 | 5 | 3 | 4 |
| 4 | F | 3 | 3 | 0 | 0 |
| 5 | D | 8 | 1 | 2 | 5 |
| 6 | E | 5 | 0 | 1 | 4 |

Song title C is seen to have the highest access number of 9 for the location L1. The media-location ranking for the location L2 would show song title A as having a highest access number of 7, and the media-location ranking for the location L3 would show song title D as having a highest access number of 5. Clearly, more song titles have been played at the location L1 than at the locations L2 and L3. In an alternate embodiment, the media-location ranking may be further delineated to include a time of day or a day of the week.

In an embodiment where media files are selected manually during playback, the media playing units 128, 228 select and present the order of song titles C, A, B, F, D, E for playback consideration at the location L1, for example. If the media files are selected automatically, the same song sequence for the location L1 would be presented wherein the song title C would begin playing. In an alternative embodiment, the media playing units 128, 228 may adjust a playback volume corresponding to a particular playback location. For example, the playback volume may be increased if the user is in a known high background noise area. Correspondingly, the playback volume may be lower if the playback location corresponds to a park or a super market.

The ranking update units 129, 229 allow for dynamically updating the media-location ranking for a playback location. This update may be done at a user's command. Alternatively, the updating may be done automatically at the conclusion of a song or stored and updated when the mobile phone 120 or 220 is either powered down or transitions to a different playback location thereby requiring another media-location ranking. Automatically updating the media-location ranking effectively allows monitoring of habits associated with a user's preferences. This monitoring may include access count or access duration to each media file experienced by the user.

For example, if a user listens to a song completely, the rating of that song increases. Alternatively, if a user skips a song or listens for a period of time that is below a threshold setting (e.g., only few seconds), the rating of that song decreases. Additionally, if a user completes a song title in the park but skips it in the city center, the song title gets a lower ranking in the city center and a higher ranking in the park. The media-location ranking can also be used to delete media files, which have not been accessed or always skipped for a certain time period. However, the ranking update units 129, 229 can accommodate media-location rankings having media priorities wherein a song title maintains a preset priority level even though it has not been accessed recently or has been skipped by a user.

The media-location rankers 125, 225 may also provide personalized media-location rankings that are associated with a particular user from a collection of users. An authentication or login process may be used to distinguish each of the particular users. Additionally, the media-location rankers 125, 225 may be implemented completely in software on an existing hardware platform, employ a combination of software and specialized hardware or use specialized hardware completely. For example, the media-location rankers 125, 225 may employ a digital storage medium or a semiconductor chip that is inserted into the mobile phones 120, 220.

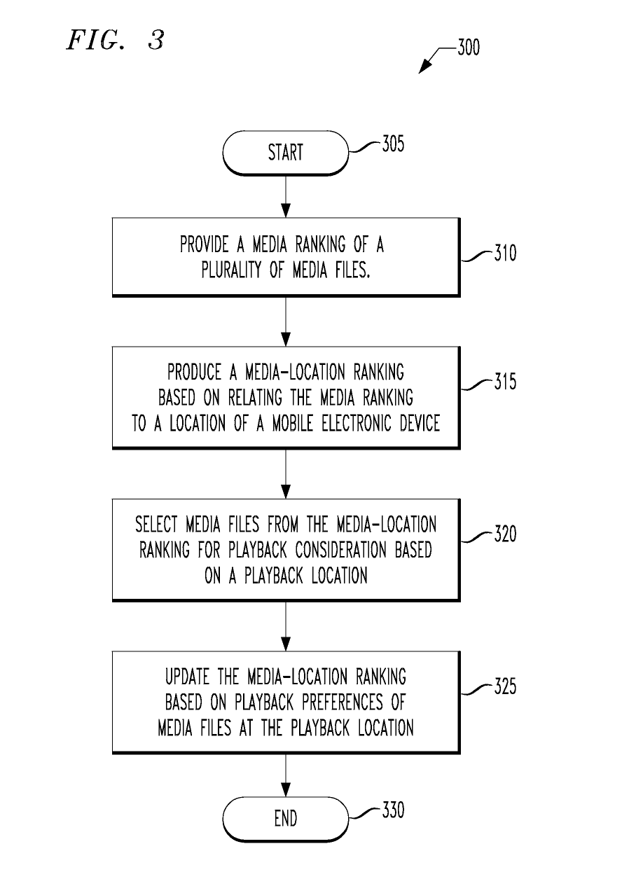

Turning now to FIG. 3, illustrated is a flow diagram of an embodiment of a method of generating a location-based media ranking, generally designated 300 and carried out in accordance with the principles of the present invention. The method 300 is for use with a mobile electronic device having a physical location awareness capability and starts in a step 305. Then, a media ranking of a plurality of media files is provided in a step 310. The media ranking provides a favorites play list. A media-location ranking, which is based on relating the media ranking to a location of the mobile electronic device, is produced in a step 315.

In one embodiment, the mobile electronic device is a mobile communication device coupled to a mobile communications network. The location of the mobile communication device may be determined by a Cell-ID of a communication cell in the mobile communications network that supports the mobile communication device. Additionally, a look-up table corresponding to the Cell-ID may be employed to determine the location of the mobile communication device. In an alternative embodiment, the location is determined by a global positioning system (GPS) wherein the mobile electronic device is able to resolve the location to a more a specific geographic location. Additionally the geographic location may correspond to one of a set of zones having similar environmental characteristics, such as parks, shopping malls, supermarkets or churches, for example.

In the illustrated embodiment, at least one media file from the media-location ranking is selected for playback consideration based on a playback location in a step 320. Selection of the media files in the step 320 may be accomplished either manually by a user or provided automatically depending on the playback location. In a step 325, the media-location ranking produced in the step 315 may be updated based on a playback preference demonstrated for the selected media files at the playback location. Again, this update may be accomplished either manually by a user or automatically based on a set of update rules and established priorities for the media-location ranking. The method 300 ends in a step 330.

While the method disclosed herein has been described and shown with reference to particular steps performed in a particular order, it will be understood that these steps may be combined, subdivided, or reordered to form an equivalent method without departing from the teachings of the present invention. Accordingly, unless specifically indicated herein, the order or the grouping of the steps is not a limitation of the present invention.

In summary, embodiments of the present invention employing a media-location ranker, a method of generating a location-based media ranking and communication and global positioning systems employing the ranker or the method have been presented. Advantages include providing a media-location ranking for media that corresponds to the location of a mobile electronic device employed by a user. This allows the media to be location-specific thereby enhancing the media experience and enjoyment afforded the user.

Although the present invention has been described in detail, those skilled in the art should understand that they can make various changes, substitutions and alterations herein without departing from the spirit and scope of the invention in its broadest form.

What is claimed is:

1. A media-location ranker for use with a mobile electronic device, comprising:
a media ranking unit configured to provide a media ranking of a plurality of media files; and
a location relating unit coupled to said media ranking unit and configured to produce a media-location ranking based on relating said media ranking to a location of said mobile electronic device.

2. The ranker as recited in claim 1 further comprising a media playing unit coupled to said location relating unit and configured to select media files from said media-location ranking for playback consideration based on a playback location.

3. The ranker as recited in claim 2 wherein selecting said media files is accomplished automatically.

4. The ranker as recited in claim 2 further comprising a ranking update unit coupled to said media playing unit and configured to update said media-location ranking based on playback preferences of media files at said playback location.

5. The ranker as recited in claim 4 wherein updating said media-location ranking is accomplished automatically.

6. The ranker as recited in claim 1 wherein said mobile electronic device is a mobile communication device coupled to a mobile communications network.

7. The ranker as recited in claim 6 wherein said location is based on a Cell-ID in said mobile communications network.

8. The ranker as recited in claim 7 wherein said location is determined by a look-up table corresponding to said Cell-ID.

9. The ranker as recited in claim 1 wherein said location is determined by a global positioning system (GPS).

10. The ranker as recited in claim 1 wherein said location is provided as a geographic location.

11. The ranker as recited in claim 10 wherein said geographic location corresponds to one of a set of zones having similar environmental characteristics.

12. A method of generating a location-based media ranking for use with a mobile electronic device, comprising:
providing a media ranking of a plurality of media files; and
producing a media-location ranking based on relating said media ranking to a location of said mobile electronic device.

13. The method as recited in claim 12 further comprising selecting media files from said media-location ranking for playback consideration based on a playback location.

14. The method as recited in claim 13 wherein selecting said media files is accomplished automatically.

15. The method as recited in claim 12 further comprising updating said media-location ranking based on playback preferences of media files at said playback location.

16. The method as recited in claim 15 wherein updating said media-location ranking is accomplished automatically.

17. The method as recited in claim 12 wherein said mobile electronic device is a mobile communication device coupled to a mobile communications network.

18. The method as recited in claim 17 wherein said location is based on a Cell-ID in said mobile communications network.

19. The method as recited in claim 18 wherein said location is determined by a look-up table corresponding to said Cell-ID.

20. The method as recited in claim 12 wherein said location is determined by a global positioning system (GPS).

21. The method as recited in claim 12 wherein said location is provided as a geographic location.

22. The method as recited in claim 21 wherein said geographic location corresponds to one of a set of zones having similar environmental characteristics.

23. A communication system, comprising:
a mobile communications network employing a cellular grid;
a mobile communication device coupled to said cellular grid; and
a media-location ranker coupled to said mobile communication device, including:
a media ranking unit that provides a media ranking of a plurality of media files,
a location relating unit, coupled to said media ranking unit, that produces a media-location ranking based on relating said media ranking to a location of said mobile electronic device,
a media playing unit, coupled to said location relating unit, that selects media files from said media-location ranking for playback consideration based on a playback location, and
a ranking update unit, coupled to said media playing unit, that updates said media-location ranking based on playback preferences of media files at said playback location.

24. The system as recited in claim 23 wherein said location is based on a Cell-ID in said mobile communication network.

25. The system as recited in claim 24 wherein said location is determined by a look-up table corresponding to said Cell-ID.

26. The system as recited in claim 23 wherein said mobile communications network conforms to a Global System for Mobile Communications/Universal Mobile Telecommunications System (GMS/UMTS) standard.

27. A global positioning system (GPS), comprising:
a satellite positioning network;
a mobile electronic device coupled to said satellite positioning network; and
a media-location ranker coupled to said mobile electronic device, including:
a media ranking unit that provides a media ranking of a plurality of media files,
a location relating unit, coupled to said media ranking unit, that produces a media-location ranking based on relating said media ranking to a location of said mobile electronic device,
a media playing unit, coupled to said location relating unit, that selects media files from said media-location ranking for playback consideration based on a playback location, and
a ranking update unit, coupled to said media playing unit, that updates said media-location ranking based on playback preferences of media files at said playback location.

28. The system as recited in claim 27 wherein said location is provided as a geographic location.

29. The system as recited in claim 28 wherein said geographic location corresponds to one of a set of zones having similar environmental characteristics.
